(19) United States
(12) Patent Application Publication
(10) Pub. No.: US 2004/0046050 A1
(43) Pub. Date: Mar. 11, 2004

(54) Sprayer with writing function

(76) Inventors: Cheng-Chuan Tai, Taipeing City (TW); Paul J. Lapeyrouse JR., Mandeville, LA (US)

Correspondence Address: BRUCE H. TROXELL, SUITE 1404, 5205 LEESBURG PIKE, FALLS CHURCH, VA, 22041, US

(21) Appl. No.: 10/234,522

(22) Filed: Sep. 5, 2002

(51) Int. Cl. B05B 15/00; B05B 17/00

(52) U.S. Cl. 239/289

(57) ABSTRACT

Sprayer with writing function, including: a main body which is a cylindrical body having two open ends, a diaphragm being integrally formed in the main body to divide the interior thereof into a first chamber and a second chamber; an atomizer disposed on a predetermined section of the open end of the first chamber, the atomizer including a nozzle seat and a nozzle unit disposed on the nozzle seat and extending into the first chamber; and a writing device disposed at a predetermined section of the open end of the second chamber and having a hollow barrel body. A pen core is disposed in the barrel body. The sprayer provides both spraying function and writing function. The sprayer has simple structure and is manufactured at low cost. In addition, it is easy to refill the sprayer with the liquid.

### BACKGROUND OF THE INVENTION

The present invention is related to a sprayer, and more particularly to a sprayer with both spraying function and writing function. In addition, it is easy to refill the sprayer with the liquid.

The current sprayer has small size and is easily portable. Such sprayer is often designed with accessory functions. The sprayer has a tubular main body and an atomizer directly plugged in one end of the main body. Several cells and a bulb are plugged in the other end of the main body. Such sprayer has simple structure and can be easily assembled. However, the outer diameter of such sprayer will be considerably large so that it is uneasy for a user to hold and write. Moreover, after the liquid contained in the sprayer is exhausted, such sprayer lacks suitable design for a user to easily refill the sprayer with the liquid.

### SUMMARY OF THE INVENTION

It is therefore a primary object of the present invention to provide a sprayer with writing function, which has simple structure and can be manufactured at low cost.

It is a further object of the present invention to provide the above sprayer with writing function. The sprayer can be easily assembled and disassembled so that a user can conveniently refill the sprayer with the liquid.

According to the above objects, the sprayer of the present invention includes: a main body which is a cylindrical body having two open ends, a diaphragm being integrally formed in the main body to divide the interior thereof into a first chamber and a second chamber; an atomizer disposed on a predetermined section of the open end of the first chamber, the atomizer including a nozzle seat and a nozzle unit disposed on the nozzle seat and extending into the first chamber; and a writing device disposed at a predetermined section of the open end of the second chamber and having a hollow barrel body. A pen core is disposed in the barrel body. The sprayer provides both spraying function and writing function. The sprayer has simple structure and is manufactured at low cost. In addition, it is easy to refill the sprayer with the liquid.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional assembled view of the first embodiment of the present invention;

FIG. 3 shows the use of the first embodiment of the present invention in one state;

FIG. 4 shows the use of the first embodiment of the present invention in another state;

FIG. 5 shows that the first embodiment of the present invention is disassembled for refilling the sprayer with the liquid; and

FIG. 6 is a sectional assembled view of a second embodiment of the present invention.

### DETAILED DESCRIPTION OF THE PREFERRED EMBODIMENTS

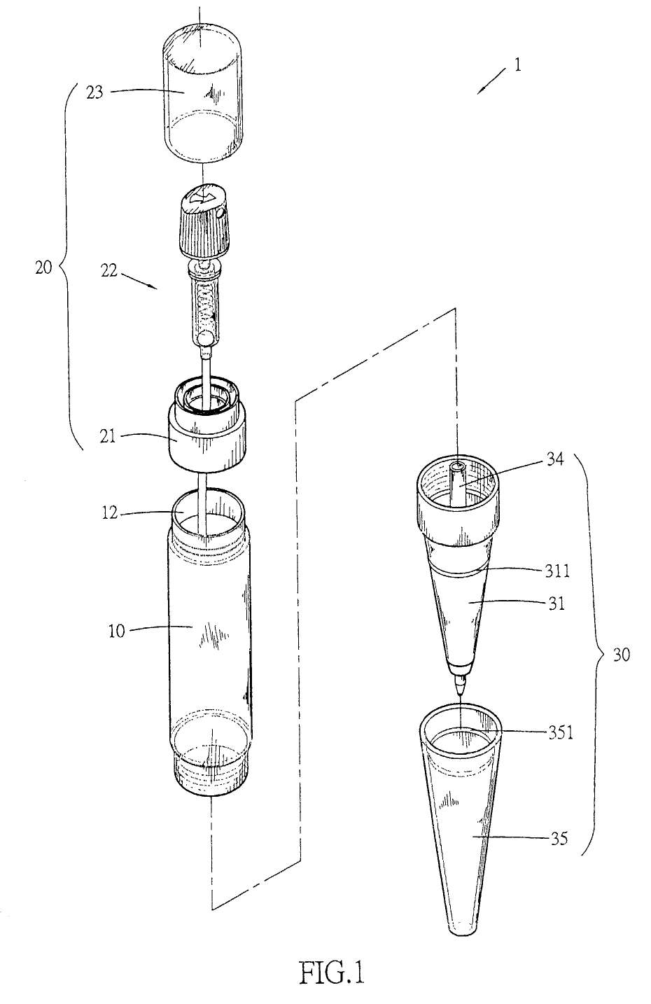

Please refer to FIGS. 1 to 5. The sprayer 1 of the present invention includes a main body 10, an atomizer 20 disposed at one end of the main body 10 and a writing device 30 disposed at the other end of the main body 10.

The main body 10 is a cylindrical body having two openings at two ends. Each end of the main body 10 is formed with a connecting section. A diaphragm 11 is integrally formed in the main body 10 to divide the interior of the main body 10 into a first chamber 12 and a second chamber 13. The capacity of the first chamber 12 is larger than that of the second chamber 13. The outer circumference of the open end of the first chamber 12 is formed with outer thread. The outer circumference of the open end of the second chamber 13 is also formed with outer thread as a first screwed section 131. The outer diameter of the main body 10 is larger than the outer diameter of the open end of the second chamber 13, whereby a step section is formed between the main body 10 and the second chamber 13.

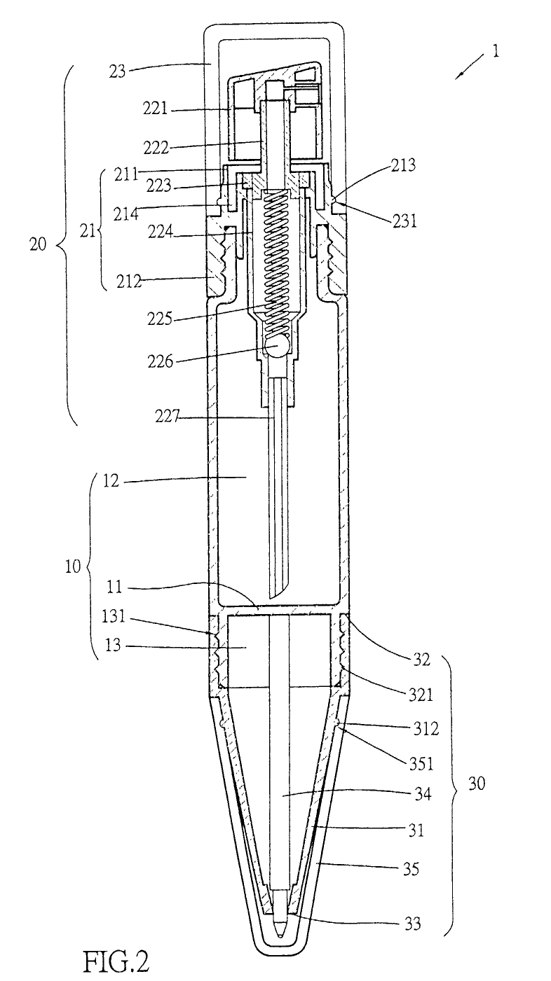

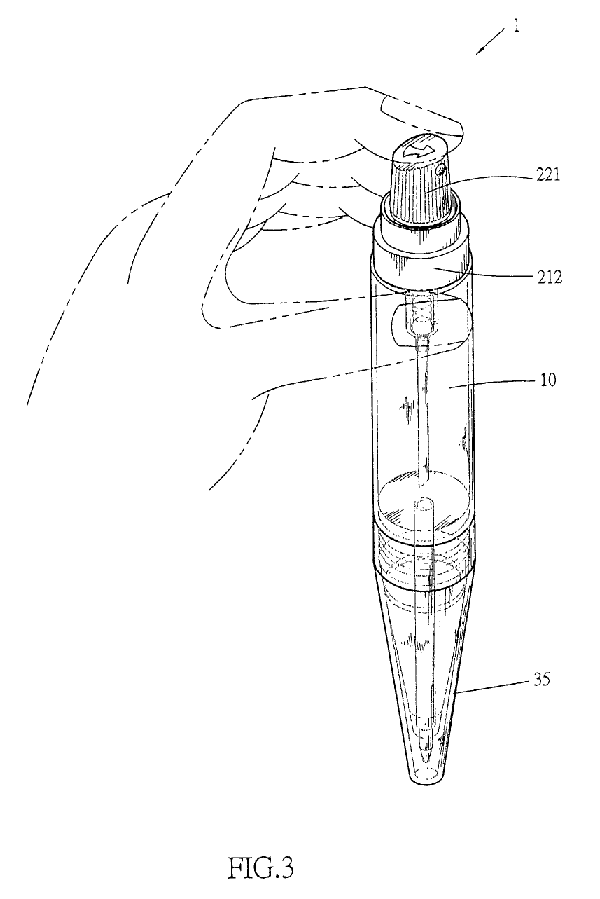

The atomizer 20 is disposed at the open end of the first chamber 12, including a nozzle seat 21. The nozzle seat 21 has an upper cylindrical seat 211 disposed on the open end with its opening facing upward (in accordance with the direction of the FIG. 2). The outer circumference of the upper cylindrical seat 211 is formed with a first engaging section 213. A lower cylindrical seat 212 is disposed at the lower end of the upper cylindrical seat 211 with its opening facing downward. The inner circumference of the lower cylindrical seat 212 is formed with inner thread, whereby the atomizer 20 is screwed with the open end of the first chamber 12. A guide section 214 is formed in the upper cylindrical seat 211 as a socket with its opening facing upward. A nozzle unit 22 is disposed on the nozzle seat 21 and composed of a movable valve 221, a hollow movable stem 222, a cock 223, a locating member 224, a spring 225, a ball member 226 and a conduit 227. Through the hollow movable stem 222, locating member 224 and the conduit 227, the movable valve 221 communicates with the first chamber 12. The movable valve 221 is up and down movably disposed in the guide section 214 of the nozzle seat 21. A cap 23 is fitted around the upper cylindrical seat 211. The inner circumference of the open end of the cap 23 is formed with a second engaging section 231 for engaging with the first engaging section 213. According to the above arrangement, a liquid contained in the first chamber 12 can be atomized and sprayed out as shown in FIG. 3.

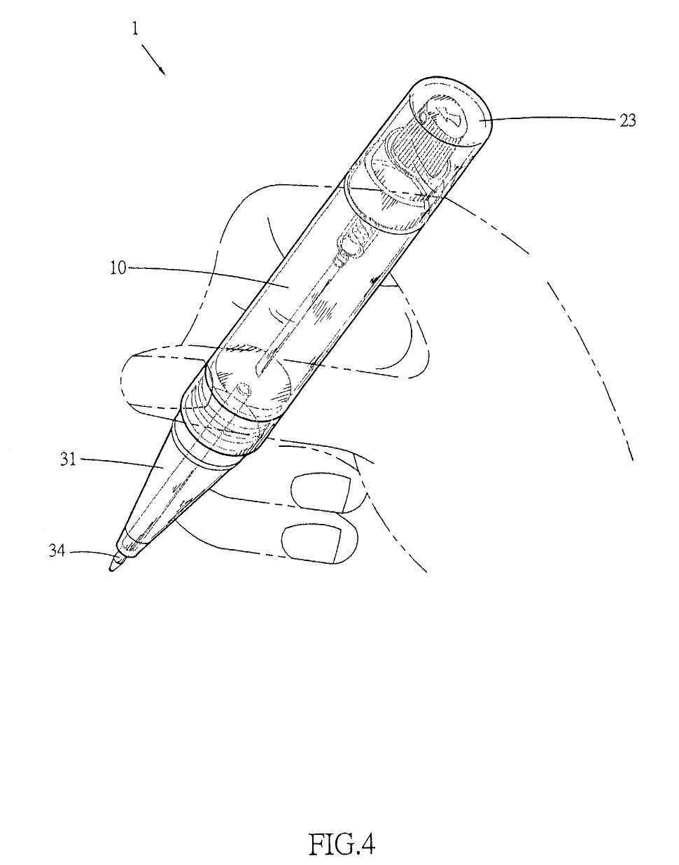

The writing device 30 is disposed at the open end of the second chamber 13 and has a hollow barrel body 31. Two ends of the barrel body 31 are respectively formed with a first opening 32 and a second opening 33. The inner circumference of the first opening 32 is formed with inner thread as a second screwed section 321 for screwing with the first screwed section 131. A pen core 34 is disposed in the barrel body 31. A writing end of the pen core 34 extends through the second opening 33 and protrudes therefrom. The other end of the pen core 34 abuts against the diaphragm 11. A pen socket 35 is fitted around the barrel body 31. The inner circumference of the open end of the pen socket 35 is formed with a first insertion section 351. The outer circumference of the barrel body 31 is formed with a second insertion section 312 adapted to the first insertion section 351. Accordingly, the writing device provides a writing function as shown in FIG. 4.

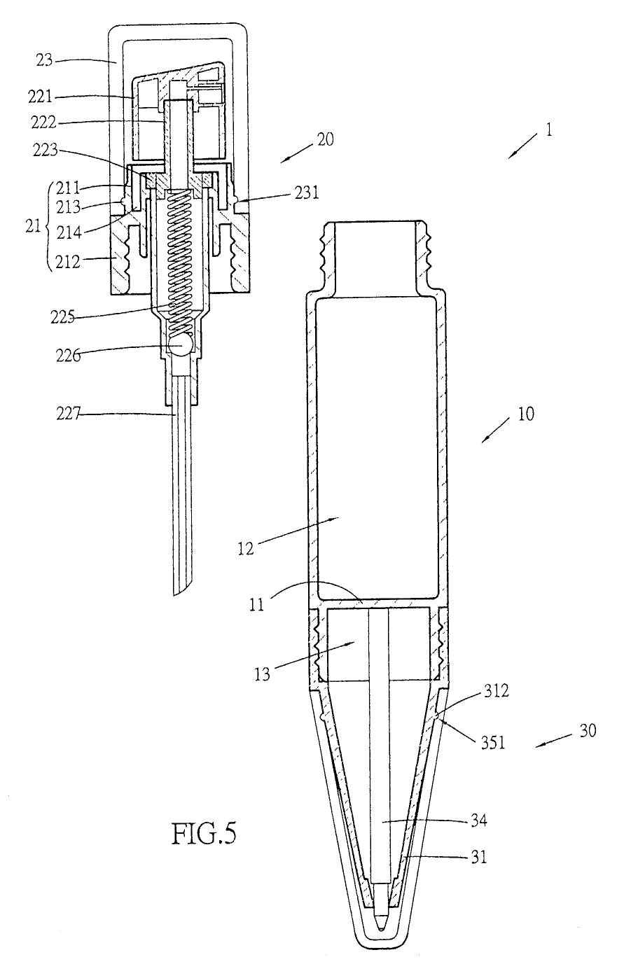

Referring to FIG. 5, when filling the liquid into the present invention, the atomizer 20 is unscrewed from the main body 10 for filling the liquid thereinto.

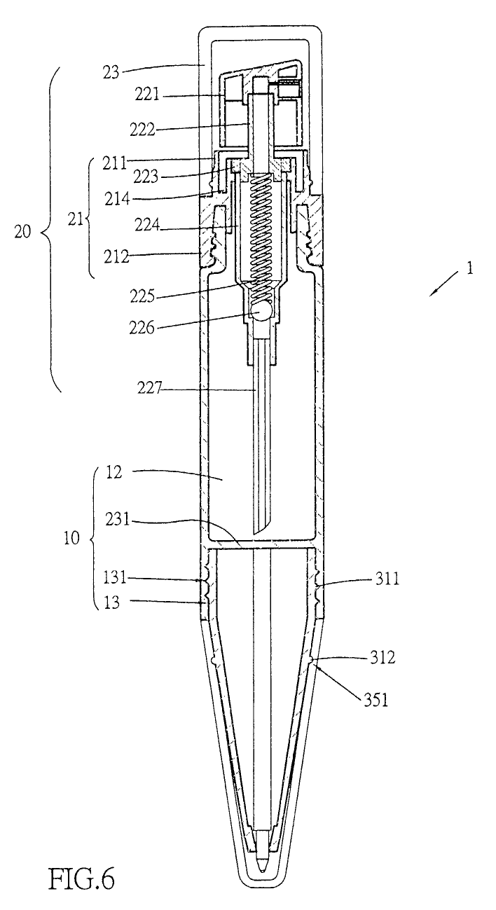

FIG. 6 shows another embodiment of the present invention, in which the outer diameter of the open end of the second chamber 13 is equal to that of the main body 10. The inner circumference of the open end of the second chamber 13 is formed with inner thread as a first screwed section 131. The outer circumference of the first opening 32 is formed outer thread as a second screwed section 321 adapted to the first screwed section 131.

According to the above arrangement, the present invention has the following advantages:

1. The diaphragm 11 is integrally formed in the main body 10 to divide the interior of the main body 10 into a first chamber 12 and a second chamber 13. The atomizer 20 and the writing device 30 are respectively disposed at two ends of the main body 10, whereby the present invention provides both spraying function and writing function.

2. The present invention has simple structure and is manufactured at low cost. In addition, the present invention can be easily assembled or disassembled. Also, it is easy to refill the sprayer with the liquid and replace the pen core.

The above embodiments are only used to illustrate the present invention, not intended to limit the scope thereof. Many modifications of the above embodiments can be made without departing from the spirit of the present invention.

What is claimed is:

1. Sprayer with writing function, comprising:
a main body which is a cylindrical body having two openings at two ends, a diaphragm being integrally formed in a predetermined section of the main body to divide the interior of the main body into a first chamber and a second chamber, the first chamber being larger than the second chamber, inner circumference of the open end of the second chamber being formed with a first screwed section;
an atomizer having a nozzle seat via which the atomizer is disposed on a predetermined section of the open end of the first chamber, a guide section being formed at upper end of the nozzle seat as a socket with its opening facing upward, a nozzle unit being disposed on the nozzle seat and composed of a movable valve, a hollow movable stem, a cock, a locating member, a spring, a ball member and a conduit, through a predetermined passage, the movable valve communicating with the interior of the main body, the movable valve being up and down movably disposed in the guide section of the nozzle seat; and
a writing device disposed at a predetermined section of the open end of the second chamber and having a hollow barrel body, two ends of the barrel body being respectively formed with a first opening and a second opening, the first opening being formed with a second screwed section adapted to the first screwed section, a pen core being disposed in the barrel body, a writing end of the pen core extending through the second opening and partially protruding therefrom, the other end of the pen core abutting against the diaphragm.

2. Sprayer with writing function as claimed in claim 1, wherein the atomizer further includes a cap fitted around the nozzle seat, inner circumference of open end of the cap being formed with a second engaging section for engaging with a first engaging section formed on outer circumference of the nozzle seat.

3. Sprayer with writing function as claimed in claim 1, wherein the writing device further includes a pen socket fitted around a predetermined section of the barrel body.

4. Sprayer with writing function as claimed in claim 3, wherein the inner circumference of the open end of the pen socket is formed with a first insertion section, the outer circumference of the barrel body being formed with a second insertion section adapted to the first insertion section.

5. Sprayer with writing function as claimed in claim 1, wherein the outer diameter of the main body is larger than the outer diameter of the open end of the second chamber, whereby a step section is formed between the main body and the second chamber.
